(19) United States
(12) Patent Application Publication
(10) Pub. No.: US 2007/0077487 A1
(43) Pub. Date: Apr. 5, 2007

(54) Battery and portable electronic device incorporating the same

(75) Inventors: Qing Yang, Shenzhen (CN); Chia-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO.,LTD, Shindian City (TW)

(21) Appl. No.: 11/474,914

(22) Filed: Jun. 23, 2006

(30) Foreign Application Priority Data
Sep. 30, 2005 (CN) 200510100105.5

(51) Int. Cl. H01M 2/02; H01M 2/10

(52) U.S. Cl. 429/187; 429/96

(57) ABSTRACT

A battery (10) includes two end surfaces and two side surfaces. One of the two end surfaces and the two side surfaces form a groove (18) pressed by a user so as to detach the battery from a housing (20). The groove does not effect the size of the battery, and the battery is easy to detach. This structure increases the convenience of user operation.

### TECHNICAL FIELD

The present invention generally relates to batteries and, particularly, to a battery for use in a portable electronic device.

### BACKGROUND

Batteries are widely used in portable electronic devices, such as personal digital assistants (PDAs), mobile phones, and so on. Some batteries are attachably received in the electronic device, and battery covers are designed to connect with housings of the electronic devices to package the batteries. The batteries have to be replaced by opening the battery covers when, for example, the batteries are damaged and/or dead (i.e. no longer rechargeable).

In a typical battery structure, a peripheral surface of the battery is a smooth surface. When the battery is detached from a housing of a portable electronic device, it is difficult to remove owing to the difficulty of getting a firm grip on the battery.

Therefore, a new battery structure is desired in order to overcome the above-described shortcomings.

### SUMMARY

In one embodiment thereof, a battery includes two end surfaces and two side surfaces. One of the two end surfaces and the two side surfaces form a groove pressed by a user so as to detach the battery from a housing.

Other advantages and novel features will become more apparent from the following detailed description when taken in conjunction with the accompanying drawings.

### BRIEF DESCRIPTION OF THE DRAWINGS

Many aspects of the battery can be better understood with reference to the following drawings. The components in the drawings are not necessarily drawn to scale, the emphasis instead being placed upon clearly illustrating the principles of the battery structure. Moreover, in the drawings, like reference numerals designate corresponding parts throughout the several views.

FIG. 1 is an exploded, isometric view of a portable electronic device employing a battery in accordance with a preferred embodiment;

FIG. 2 is similar to FIG. 1, but viewed from another aspect;

FIG. 3 is an assembled view of the portable electronic device shown in FIG. 1; and

FIG. 4 is a cross-sectional view of FIG. 3.

### DETAILED DESCRIPTION OF THE EMBODIMENTS

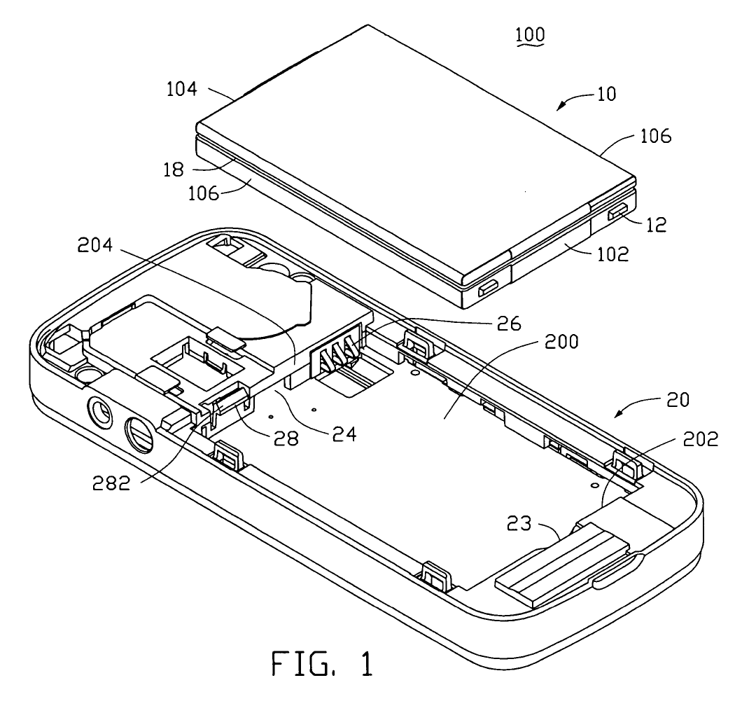

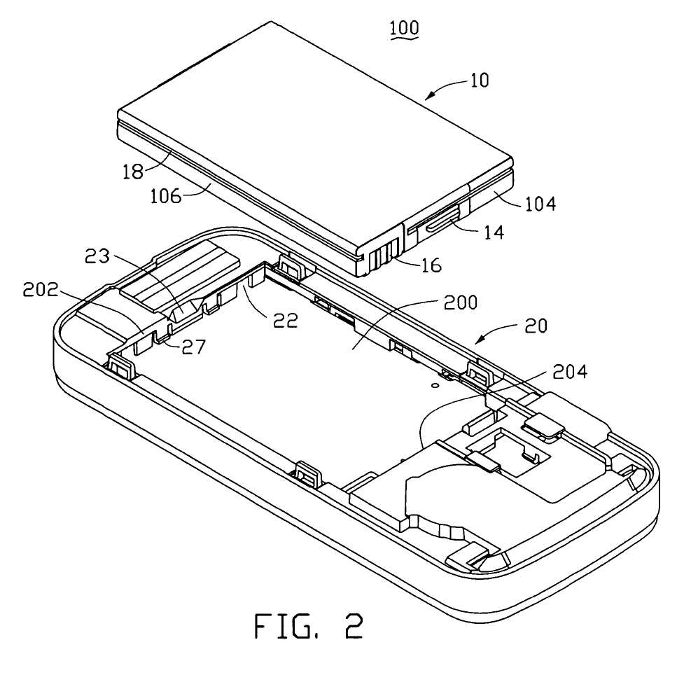

Referring now to the drawings in detail, FIGS. 1 and 2 show a portable electronic device 100 such as a mobile phone employing a battery 10. The mobile phone 100 is taken here as an exemplary application, for the purposes of describing details of a battery assembly of a preferred embodiment.

The battery 10 is substantially a long cube, and includes a first end surface 102, a second end surface 104 and two opposite side surfaces 106. The first end surface 102 is positioned opposite the second end surface 104. Two spaced projections 12 are formed on the first end surface 102. A protrusion 14 is formed in a middle portion of the second end surface 104. Adjacent to the protrusion 14, a conductive terminal 16 is set on the second end surface 104. A loop groove 18 is defined in the first end surface 102, the second end surface 104 and the two side surfaces 106. The loop groove 18 is also above the projections 12.

The housing 20 is a back housing of the mobile phone 100. The housing 20 has a receiving cavity 200 defined cooperatively by a first portion 202, a second portion 204, two side portions (not labeled) and a bottom portion 206. The receiving cavity 200 is adapted for receiving the battery 10 therein. The first portion 202 defines a cutout 22 adjacent to each side portion. Each of the cutouts 22 is used for receiving a corresponding projection 12. Two spaced clasps 27 are formed in the first portion 202 and are positioned between the two cutouts 22. A concave portion 23 is formed at a middle area of the first portion 202 and is positioned between the clasps 27. The second portion 204 defines a locking opening 24 in a middle portion thereof for receiving the protrusion 14. A connector 26 is positioned on the second portion 204. The connector 26 may be electrically connected to the conductive terminal 16 of the battery 10. A hook 28 is formed on second portion 204 at one side of the locking opening 24 opposite to the connector 26. The hook 28 has a wedge-shaped distal end 282.

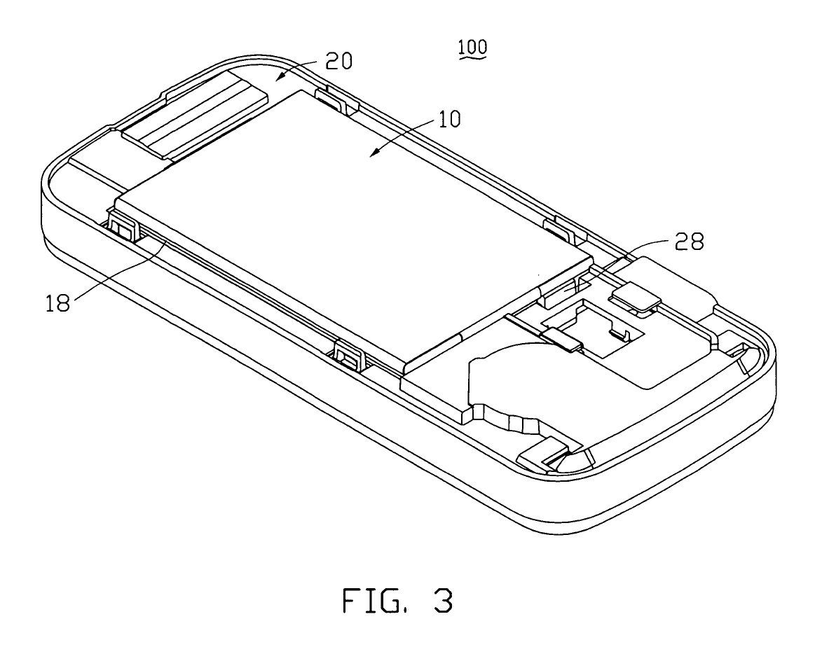

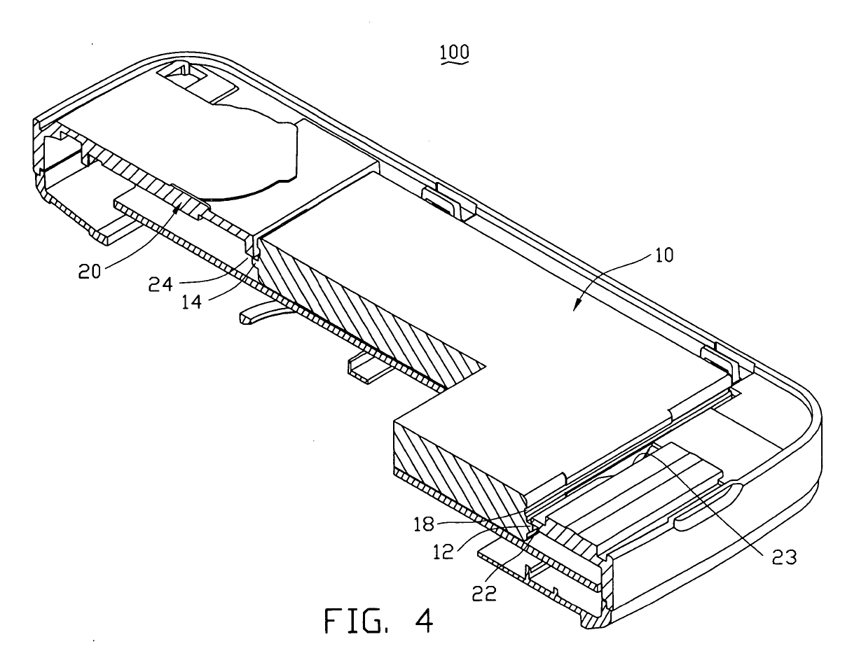

In assembly, referring now to FIGS. 3 and 4, each projection 12 of the battery 10 is inserted into a corresponding cutout 22 of the housing 20. At the same time, the conductive terminal 16 of the battery 10 faces towards the connector 26 of the housing 20, and the second end surface 104 of the battery 10 faces towards the hook 28. Then, the battery 10 is pressed downward, with the second end surface 104 sliding relative to the wedge-shaped distal end 282. Finally, the protrusion 14 engages into the locking opening 24 of the housing 20, and the distal end 282 of the hook 28 deformably engages into the loop groove 18. The clasps 27 are deformable under the role of the battery 10 so as to tightly press on the battery 10. In this way, the battery 10 can be positioned in the receiving cavity 200 of the housing 20.

When the battery 10 is detached from the housing 20, the loop groove 18 of the battery 10 at the concave portion 23 of the housing 20 is exposed. A user's finger may be grip the loop groove 18 of the second surface 104 to push toward the direction of the second end surface 104. Owing to the design of the loop groove 18, the battery 10 may be firmly griped. Therefore, the hook 28 falls out from the loop groove 18, the protrusion 14 detaches from the locking opening 24, the projections 12 fall out from the cutouts 22 of the housing 20, and as a result, the battery 10 is detached from the housing 20.

A main advantage of the battery 10 is that the loop groove 18 does not effect the size of the battery 10, and the battery 10 may easily be detached as a result. Furthermore, the hook 28 can be more freely positioned because of the position of the loop groove 18. In other words, the hook 28 is not limited to being positioned on the second portion 204, and may be positioned anywhere on an inner periphery of the housing 20 for engaging in the loop groove 18 so as to fix the battery 20 in the housing 20. In addition, when the height of the battery 10 is higher than the housing 20, the concave portion 23 may be omitted. When the battery 10 is detached from the housing 20, the user may directly push any surface of the first end surface 102, the second end surface 104 and two side surfaces 106. This structure is much more easy to use than conventional apparatuses.

In alternative embodiments, the groove may be replaced with other structure such as a ridge or a rough surface acting as a grip portion pressed by a user so as to detach the battery from the housing.

As described above, the preferred embodiment provides a battery 10 for devices such as mobile phones, which is both simple and easy to use. It is, however, to be understood that the battery 10 could potentially be useful in other applications in which it may be desirable to allow the battery 10 to be separated.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A battery comprising:
two end surfaces; and
two side surfaces;
wherein at least one of the two end surfaces and the two side surfaces forms a groove, the groove is configured for grip by a user when detaching the battery from a housing.

2. The battery as claimed in claim 1, wherein the end surfaces include a first end surface and an opposite second end surface, the first end surface forms two spaced projections, and the second end surface forms a protrusion in a middle portion thereof.

3. The battery as claimed in claim 2, wherein a conductive terminal is set on the second surface adjacent to the protrusion.

4. The battery as claimed in claim 3, wherein the groove is defined in the first end surface, and the second end surface and two side surfaces.

5. A portable electronic device comprising:
a battery having a grip portion formed along a periphery thereof; and
a housing defining a receiving cavity for receiving the battery, and a concave portion configured for exposing the grip portion;
wherein when the battery is detached from the housing, the grip portion of the battery is pushed by a user so as to separate the battery from the housing.

6. The portable electronic device as claimed in claim 5, wherein the battery includes two end surfaces and two side surfaces, the grip portion is a groove defined in the two end surfaces and two side surfaces, the housing forms a hook, and the hook is received in the groove.

7. The portable electronic device as claimed in claim 6, wherein one of the end surfaces of the battery set two spaced projections, and the housing defines two cutouts at one end thereof opposite to the hook, each projection engages into a corresponding cutout.

8. The portable electronic device as claimed in claim 7, wherein the other of the end surfaces of the battery has a protrusion, the housing defines a locking opening for receiving the protrusion adjacent to the hook.

9. The portable electronic device as claimed in claim 8, wherein a conductive terminal is set adjacent to the protrusion, the housing sets a connector at one side of the hook thereof for electrically connecting to the conductive terminal.

10. The portable electronic device as claimed in claim 9, wherein the housing forms two spaced clasps between the cutouts, the clasps press the battery into the housing so as to fix the battery in the housing.

11. A portable electronic device comprising:
a housing having a receiving cavity defined therein, the housing including at least one clasp formed proximate to the receiving cavity; and
a battery sized to engage in the receiving cavity, the battery having a groove formed in a periphery thereof, the groove configured for receiving the clasp therein so as to lock the battery in the receiving cavity, the groove configured for grip by a user when detaching the battery from the receiving cavity.

12. The portable electronic device as claimed in claim 11, wherein the battery has two end surfaces and two side surfaces, and the groove is defined in the two end surfaces and two side surfaces.
